(19) United States
(12) Patent Application Publication
(10) Pub. No.: US 2016/0159560 A1
(43) Pub. Date: Jun. 9, 2016

(54) Portable Storage and Display Enclosure

(71) Applicant: Goodness Gardens, Inc., New Hampton, NY (US)

(72) Inventor: Brian Murphy, New Hampton, NY (US)

(73) Assignee: GOODNESS GARDENS, INC., New Hampton, NY (US)

(21) Appl. No.: 14/537,954

(22) Filed: Dec. 9, 2014

(51) Int. Cl. B65D 85/50; A23L 1/212; B65D 81/26; B65D 81/22; B65D 43/16; B65D 25/04

(52) U.S. Cl. CPC B65D 85/50; B65D 43/163; B65D 25/04; B65D 81/261; B65D 81/22; A23L 1/212; B65D 2543/00203; A23V 2002/00

(57) ABSTRACT

An apparatus for storing and displaying herbs that includes a body defining a cavity, dividers arranged within the cavity of the body, and a lid that is connected to the body and rotatable between an open position to allow a consumer to select the herbs and a closed position to extend the shelf life of the herbs and protect the herbs from contamination. The apparatus is portable, can be arranged on a store shelf and is restockable.

### FIELD OF THE INVENTION

The present invention relates generally to an enclosure and more particularly to a portable enclosure that can be shipped to and then arranged on a shelf of a store for storing, displaying, and maintaining the freshness of loose bunched herbs or other vegetative produce.

### BACKGROUND OF THE INVENTION

Containers that can be used to house and display a variety of items, including herbs and/or other vegetative produce, are known. The size, shape, and features of storage containers can vary depending the intended use of the container. For example, many storage containers found in grocery stores that contain herbs and/or other vegetative produce have a clamshell design such that the container is releasably sealed to house a select amount of a product for individual sale. Alternatively, herbs and/or other vegetative produce may be individually heat sealed in packaging or bundled. Bundled herbs and other vegetative produce are commonly placed on shelves of a grocery store and misted with water to extend their shelf life. However, misting systems regularly contain bacteria, which can be transferred to the product. The shelf life of prepackaged herbs and other vegetative produce can be shorter than those that are bundled because prepackaged products are not regularly misted and the packaging commonly absorbs moisture produced by the herbs and/or other vegetative produce, which prevents the container and/or packaging from acting as a greenhouse for the product.

Greenhouses, which typically are comprised of glass and/or plastic walls and a roof can aid in promulgating the growth of plants, vegetables and the like by creating a humid environment which in turn allows the vegetation therein to thrive. Greenhouses however are not designed to be portable, and shippable to retail stores and capable of storing, displaying, and maintaining the freshness of cut vegetative produce and herbs at such retail locations.

### SUMMARY OF THE INVENTION

The present invention is directed to a portable storage and display enclosure that has a rotatable lid that is connected to the enclosure unit, which can easily be shipped to a retail location, such as a grocery store, to house, display, and maintain the freshness of loose bunched herbs or other vegetative produce. When arranged in the enclosure, the herbs can naturally create, over a period of time, a humid environment (e.g., greenhouse) by the transpiration of water given off by the herbs that collects primarily on the lid of the container which helps to keep the herbs fresh. By creating a self-moisturizing unit, the enclosure can substantially prevent possible contamination by bacteria that is commonly found in misting and other watering systems at a place of purchase (e.g., grocery store) while maintaining the freshness of herbs or other vegetative produce that are housed and displayed in the container.

In an embodiment, a portable container for storing and displaying loose bunched herbs at a retail location that is configured to sit on a shelf of said retail location comprises a body having connected side walls, including a front wall and a rear wall and a flat bottom wall extending between the side walls, the body defining a cavity having a depth that increases from the front wall to the rear wall and said flat bottom wall being sized to sit on the shelf at said retail location, a plurality of dividers arranged within the cavity of the body in rows that extend from the front wall to the rear wall and are sized to hold the loose bunched herbs, and a lid that is rotatably mounted on the body for rotation between an open position exposing the herbs and a closed position to retain moisture within the container and maintain freshness of the herbs arranged therein. The container can be substantially transparent, and the base can include a plurality of openings to allow for drainage.

In an embodiment, the container can further comprise a plurality of the loose bunched herbs arranged within the cavity of the body in front to back rows between the dividers.

In an embodiment, the container can further comprise a first sidewall and a second sidewall extending outwardly from the body between the front wall and the rear wall in a same direction with each of the first sidewall and the second sidewall substantially forming an apex. In an embodiment, the first and second sidewalls can each extend outwardly from the front wall at a first angle and the rear wall at a second angle that is different from the first angle with the first angle and the second angle substantially converging with each other to substantially form the apex. In an embodiment, the first sidewall and the second sidewall can each include an opening and the lid can extend through each opening to secure the lid to the base.

In an embodiment, the rear wall is taller than the front wall. In an embodiment, the rear wall can include a protrusion extending at an angle away from the base, and in the open position the protrusion can be contactable by the first portion of the lid to prevent the first portion from rotating beyond the protrusion.

In an embodiment, the lid includes a first portion, a second portion extending at a first angle from the first portion and a third portion extending from the second portion at a second angle. The dividers can each substantially form a U-shape.

In an embodiment, the dividers can include a first portion, a second portion extending at a first angle from the first portion and a third portion extending at a second angle from the second portion. The first portion can define a first height and the third portion can define a second height and the height of the first portion can be shorter than the height of the third portion, and the second portion can define an outer boundary that increases from the height of the first portion to the height of the third portion.

In an embodiment, a loaded portable container configured to sit on a shelf at a retail location can comprise a body having connected side walls, including a front wall and a rear wall and a flat bottom wall extending between the side walls, said body defining a cavity having a depth that increases from the front wall to the rear wall and said body being sized to sit on the shelf at said retail location, a plurality of dividers arranged within the cavity of the body in rows that extend from said front wall to said rear wall, a plurality of loose bunched herbs or other produce arranged within the cavity of said body in front to back rows between the dividers and a lid rotatably mounted on the body for rotation between an open position exposing the loose bunched herbs arranged therein and a closed position to retain moisture within the container and maintain freshness of the loose bunched herbs arranged therein.

### BRIEF DESCRIPTION OF THE DRAWINGS

FIG. 1 is a perspective view of an embodiment of a storage and display enclosure for herbs and/or other vegetative produce of the present invention;

FIG. 2 is a cross-sectional side view of the enclosure taken along line 2-2 of FIG. 1;

FIG. 3 is a top plan view of the enclosure taken along line 3-3 of FIG. 1;

FIG. 4 is a sectional side view of the enclosure of FIG. 1 showing the lid in various states between closed and open positions, such various states being shown by dot and dash lines; and

FIG. 5 is an assembly view of the container of FIG. 1 showing its various components.

### DETAILED DESCRIPTION OF EMBODIMENTS OF THE INVENTION

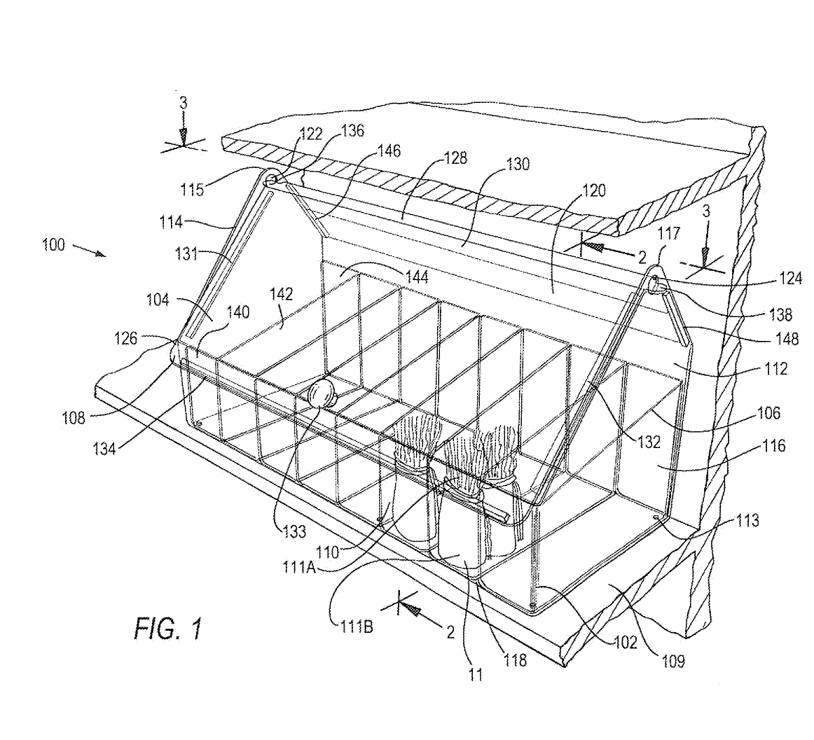

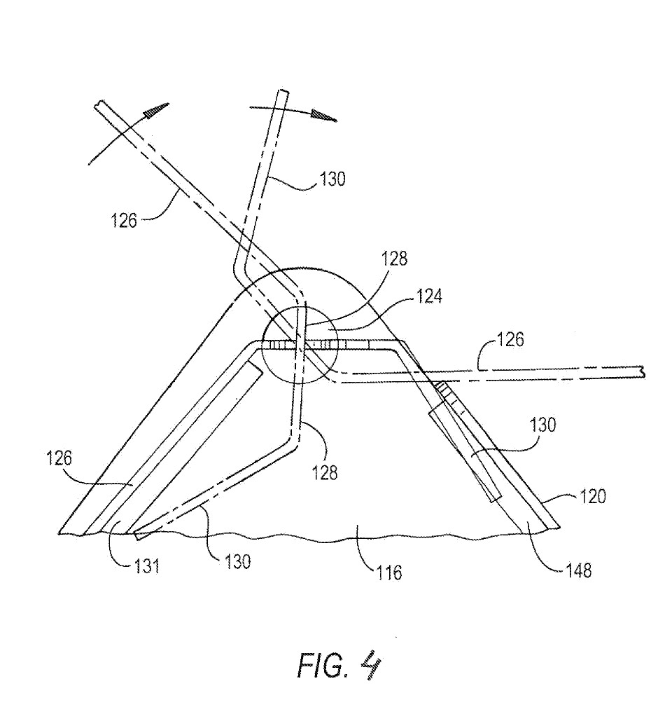

FIGS. 1-5 illustrate an embodiment of a shippable and portable storage and display enclosure for herbs and/or other produce is designated hereinafter by reference numeral 100. The portable enclosure 100, which can act as a container having properties similar in certain ways to a greenhouse, includes a body 102 defining a cavity 104 in which a plurality of dividers 106 are arranged and a rotatable lid 108 that is secured to the container body 102.

As shown in FIG. 1, the enclosure 100 can be arranged on a shelf 109 of a retail store, especially a supermarket, so as to display fresh herbs or like produce, for selection and purchase by a consumer. The enclosure 100 is a refillable, self-moisturizing unit that preserves the freshness of the herbs 111 or like produce by creating a humid environment. The humid environment is created by the transpiration of water given off by the herbs 111 arranged in the enclosure 100, which collects primarily on the lid 108 of the body 102 to keep the herbs 111 from wilting and/or rotting. By creating a self-moisturizing unit, the enclosure 100 prevents the possible contamination of the herbs 111 by bacteria that is commonly found in misting systems at a place of purchase, such as a grocery store. Thus, the freshness of the herbs 111 is preserved while the possible contamination of the herbs 111 and/or other produce is substantially reduced.

The herbs 111 are loose bunched and typically include freshly cut herbs 111 that are wrapped at their lower ends in a removable covering such as paper or a film. The herb 111 bundles are approximately about 1½ inches to 2 inches in diameter. However, the size of the bundles can be larger or smaller depending on the desired quantity of the herbs 111. As used here, the term “loose bunched herbs” includes other produce, which is pre-cut and which benefits from moisturization.

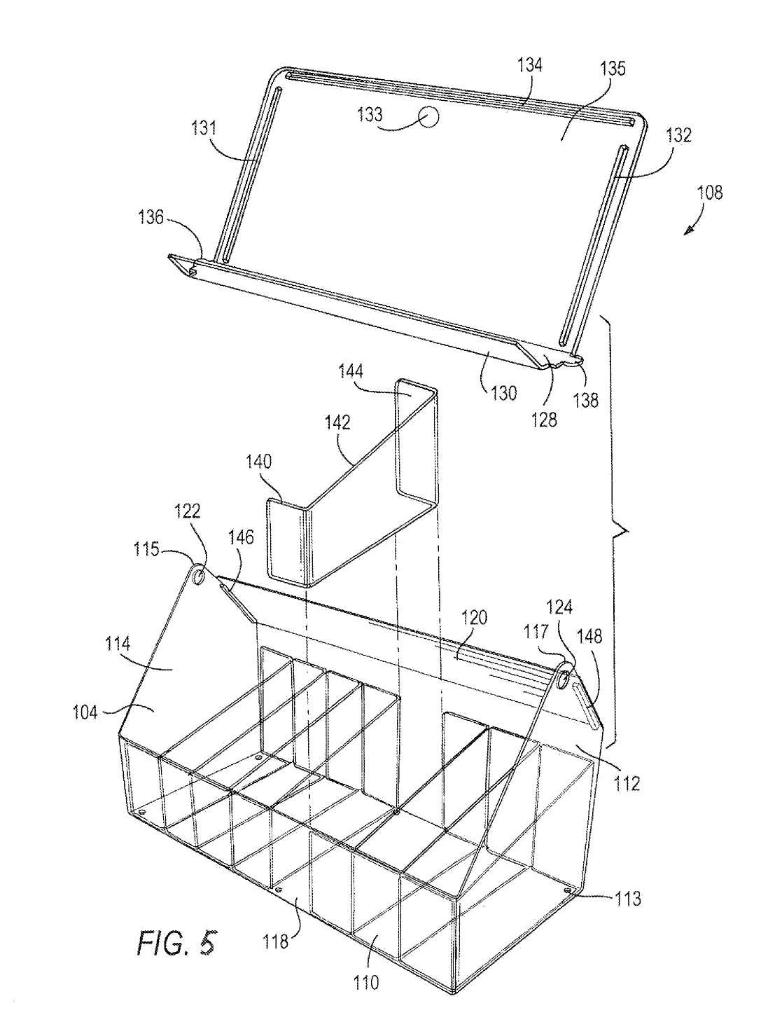

The enclosure 100 is preferably made of transparent polycarbonate, which does not absorb moisture to ensure the sustainability of the greenhouse environment within the container 100. However, the container 100 can be made out of any other material that is known or may become known that is does not absorb moisture. Any excessive moisture can exit the body 102 through a plurality of weeper or drainage holes 113 extending at various locations through the body 102 (see FIGS. 1 and 5). In an embodiment, the body 102, dividers 106 and substantially the lid 108 can formed from sheets of polycarbonate that are cut and then heated to form the container body 102, the lid 108 and the dividers 106. Alternatively, features of the apparatus 100 can be molded.

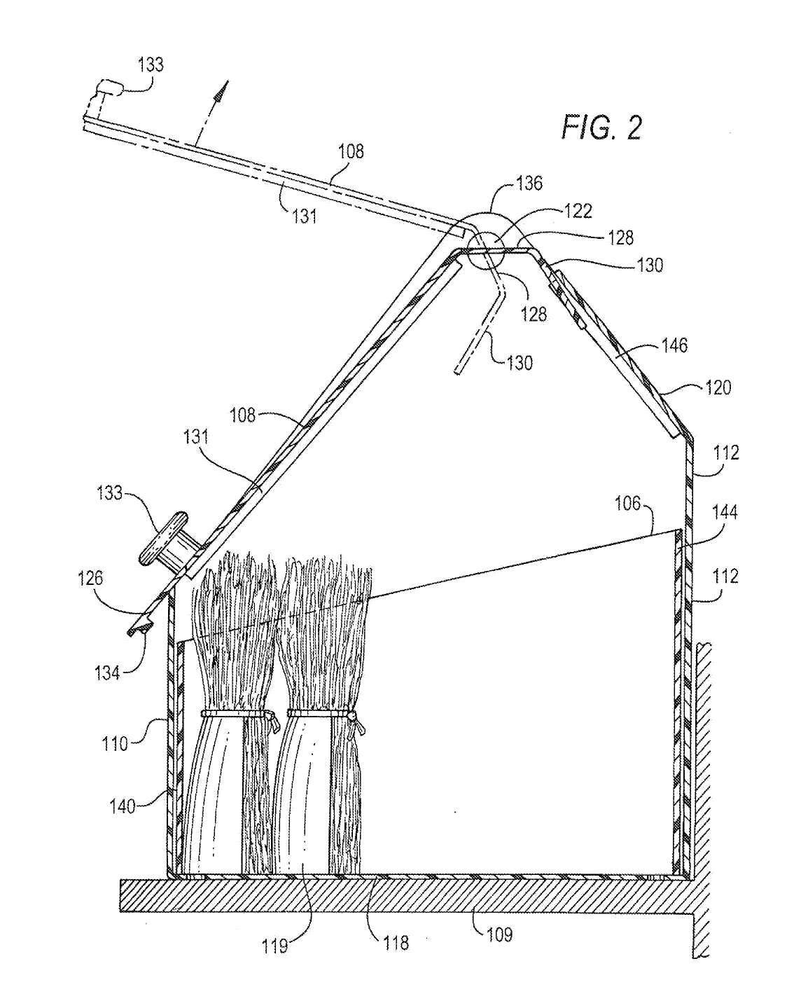

The body 102 of the container 100 includes a flat front wall 110, a flat rear wall 112, a first sidewall 114, a second sidewall 116, a base 118, and a slanted partial top 120 extending from the rear wall 112. In an embodiment, the base 118 can be about 22 inches long by 10 inches wide. The slanted partial top wall 120, which, in an embodiment, can be about 22½ inches long by approximately 4 inches wide, includes downward protrusions 113, 115. In an embodiment, the protrusions 113, 115 are about 3½ inches in length by ¼ inch in height and ¼ inch in width. As can be seen, for example, in FIGS. 1 and 2, the front wall 110 is shorter than the rear wall 112. In an embodiment, the front wall 110 is approximately 5 inches tall by 22 inches wide and the rear wall 112 is approximately 8½ inches tall by 22 inches wide. The sidewalls 114, 116 are parallel, extend outwardly in a same direction from the base 118 and each substantially forms an apex 117, 119. As shown in FIGS. 1 and 2, the sidewalls 114, 116 each extend outwardly from the front wall 110 at a first angle and sidewalls 114, 116 extend outwardly from the rear wall 112 at a second angle that is different from the first angle. This is due to the difference in height between the front wall 110 and the rear wall 112. In an embodiment, the sidewalls 114, 116 are approximately about 10 inches in width and 12½ inches in height. Both of the sidewalls 114, 116 include an opening 122, 124 near the apexes 115, 117. The openings 122, 124, which are each about ¾ inch in diameter, allow the pivot extensions 136, 138 and the lid 108 to extend therethrough and rotate between and open and closed position (e.g., FIG. 5). However, the size of features of the body 102 can be larger or smaller depending on, for example, client need and/or shelf space. As such, the dimensions provided herein are merely illustrative.

The lid 108 includes a first portion 126, a second portion 128 extending at an angle from the first portion 126, and a third portion 130 extending at an angle from a side of the second portion 128 that is opposite the first portion 126 in an opposite direction than the angle which the first portion 126 extends. The first portion 126, which, in an embodiment, is slightly less than 22 inches in width and has a height of about 10 1/12 inches, includes three bumper strips 131, 132, 134 that are spaced apart from each other and fixed to a first surface 136 of the first portion 126. The first strip 131 and the second strip 132 are spaced from each other and extend parallel to each other near opposite edges of the first portion 126. In an embodiment, these strips 131, 132 are approximately 8½ inches long by ¼ inch in height and ¼ in width. The third strip 134 extends longitudinally about the first portion 126 and perpendicular to the first and the second strips 131, 132. In an embodiment, the third strip 134 is approximately 21 inches long by ¼ inch in height and ¼ in width. A knob or handle 133 can be fixed (e.g., screwed, application of adhesive) to a second side 135 of the first portion 126 to aid in opening and closing the lid 108.

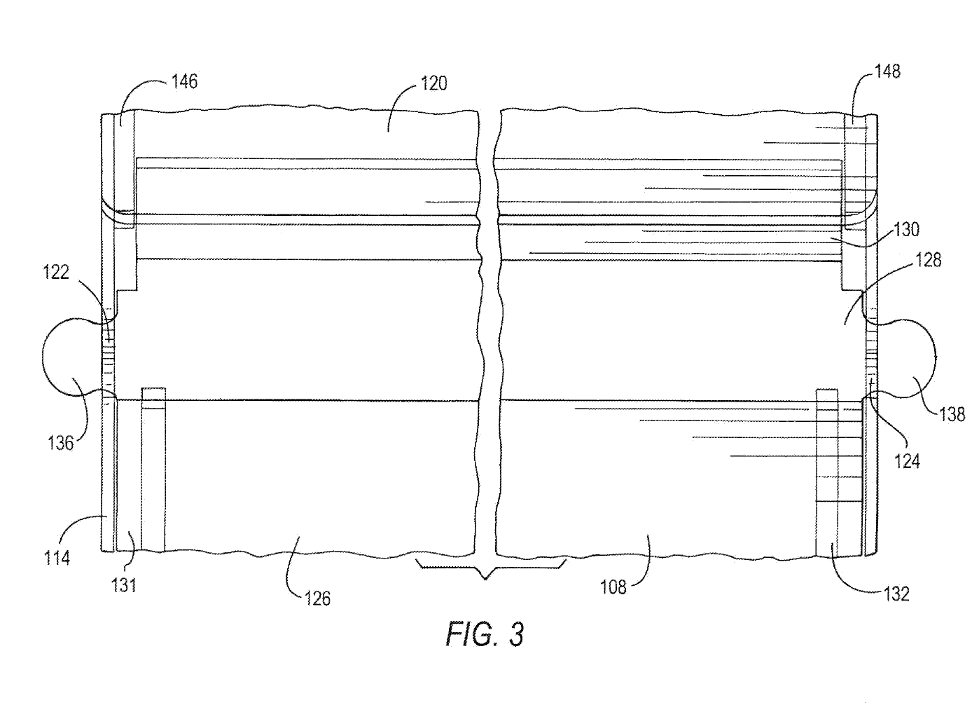

The second portion 128, which, in an embodiment, is approximately 21 inches in length by 1¼ inch in width, includes a first and second pivot extension 136, 138 that extend outwardly at opposite ends of the second portion 128. As can be seen in FIGS. 1 and 3, each pivot extension 136, 138 has a rounded outer boundary that extends through the openings 122, 124 in the sidewalls 114, 116, respectively. The third portion 130 has a width that is narrower that the first portion 126 to allow the third portion 130 to be arranged between the sidewalls 114, 116 and rotatable for opening and closing of the lid 108 and includes a first protrusion 146 and a second protrusion 148 fixed thereto. In an embodiment, the third portion 130 is approximately 19½ inches in length by 2 inches wide. However, the dimensions of the second and third portions 128, 130 can be larger or smaller depending on, for example, client need and/or shelf space. As such, the dimensions provided herein are merely illustrative.

The dividers 106 are provided to house and hold erect the loose bunched herbs within the enclosure, so that they can be readily viewed and removed upon purchase by a customer at a retail store. The dividers 106 include a first portion 140, a second portion 142 extending at a first angle from the first portion 140, and a third portion 144 extending at a second angle from the second portion 142 to house a three-sided unit. (See FIG. 3). The dividers 106 each substantially form a U-shape, and are arranged in rows within the body 102, from the front to the back thereof. The first portion 140, which in an embodiment can be about 2½ inches in width, defines a first height and the third portion 144, which in an embodiment can be about 2½ inches in width, defines a second height. The dividers 106 therefore being downwardly slanted (see FIGS. 2 and 3). The height of the first portion, which in embodiment is approximately 5 inches, is shorter than the height of the third portion 144, which in an embodiment is approximately 6½ inches. The second portion 142, which in an embodiment can be about 9¾ inches in length, defines an outer boundary that increases from the height of the first portion 140 to the height of the third portion 144. The dividers 106 are sized to present single rows of the herbs, one in front of another, from the front to the back of the enclosure (see FIG. 1).

As shown in FIG. 5, the dividers 106 can each be removably arranged within the cavity 104 of the body 102 for separation of produce and/or herbs 111. In an embodiment, eight dividers are arranged within the cavity 104 of the body 102. However, depending on the size of the body 102 and the produce and/or herbs 111 arranged between the dividers 106 in the body 102, the number and size of dividers 106 can be increased or decreased from those shown in FIGS. 1 and 5.

Typically, the container 100 is initially shipped to a retail store where fresh cut herbs and/or produce 111 can be found. Upon arrival at the store, an employee will place the container 100 on a shelf in the produce section of a retail location. Between each of the dividers 106, the unit 100 will then be loaded with a plurality of freshly cut loose bunched herbs 111 with the herbs being arranged in rows, one in front of the other, in the rows provided by the dividers 106. The herbs 111 will be loaded in an upright position in a plurality of rows and the lid 108 will then be closed. Over a period of time, the herbs 111 will create a self-moisturizing unit to prolong their freshness. Because the container 100 is transparent, a consumer can easily view the herbs 111 arranged therein and can open the lid 108 to select desired fresh herbs 111 for purchase and close the lid 108 after such selection has been made. Alternatively, the container 100 may be pre-loaded with the herbs.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations (e.g., size and shape of various features of the embodiments of the containers) to those embodiments can be made by those skilled in the art without departing from the scope of the invention.

What is claimed is:

1. A portable container for storing and displaying loose bunched herbs at a retail location, the container being configured to sit on a shelf of said retail location, the container comprising:
a body having connected side walls, including a front wall and a rear wall and a flat bottom wall extending between the side walls, said body defining a cavity having a depth that increases from the front wall to the rear wall and said flat bottom wall being sized to sit on the shelf at said retail location;
a plurality of dividers arranged within the cavity of the body, the dividers being arranged in rows that extend from the front wall to the rear wall and being sized to hold the loose bunched herbs; and
a lid rotatably mounted on the body for rotation between an open position exposing the herbs and a closed position to retain moisture within the container and maintain freshness of the herbs arranged therein.

2. The container of claim 1, further comprising a plurality of the loose bunched herbs arranged within the cavity of the body in front to back rows between the dividers.

3. The container of claim 1, wherein the rear wall is taller than the front wall.

4. The container of claim 1, further comprising a first sidewall and a second sidewall extending outwardly from the body between the front wall and the rear wall in a same direction, each of the first sidewall and the second sidewall substantially forming an apex.

5. The container of claim 4, wherein the first sidewall and the second sidewall each extend outwardly from the front wall at a first angle and the rear wall at a second angle that is different from the first angle with the first angle and the second angle substantially converging with each other to substantially form the apex.

6. The container of claim 4, wherein the first sidewall and the second sidewall each include an opening and the lid extends through each opening to secure the lid to the base.

7. The container of claim 1, wherein the rear wall includes a protrusion extending at an angle away from the base.

8. The container of claim 1, wherein the lid includes a first portion, a second portion extending at a first angle from the first portion and a third portion extending from the second portion at a second angle.

9. The container of claim 8, wherein the rear wall includes a protrusion extending at an angle away from the base, and in the open position the protrusion is contactable by the first portion of the lid to prevent the first portion from rotating beyond the protrusion.

10. The container of claim 1, wherein the dividers include a first portion, a second portion extending at a first angle from the first portion and a third portion extending at a second angle from the second portion.

11. The container of claim 11, wherein the first portion defines a first height and the third portion defines a second height and the height of the first portion is shorter than the height of the third portion, and the second portion defines an outer boundary that increases from the height of the first portion to the height of the third portion.

12. The container of claim 1, wherein the dividers each substantially form a U-shape.

13. The container of claim 1, wherein the container is substantially transparent.

14. The container of claim 1, wherein the base includes a plurality of openings to allow for drainage.

15. A loaded portable container configured to sit on a shelf at a retail location, comprising:
a body having connected side walls, including a front wall and a rear wall and a flat bottom wall extending between the side walls, said body defining a cavity having a depth that increases from the front wall to the rear wall and said body being sized to sit on the shelf at said retail location;
a plurality of dividers arranged within the cavity of the body in rows that extend from said front wall to said rear wall;
a plurality of loose bunched herbs or other produce arranged within the cavity of said body in front to back rows between the dividers; and
a lid rotatably mounted on the body for rotation between an open position exposing the loose bunched herbs arranged therein and a closed position to retain moisture within the container and maintain freshness of the loose bunched herbs arranged therein.

16. The container of claim 15, wherein the rear wall is taller than the front wall.

17. The container of claim 15, further comprising first sidewall and the second sidewall extending outwardly from the body between the front wall and the rear wall in a same direction and each of the first sidewall and the second sidewall substantially form an apex, wherein the first sidewall and the second sidewall each extend outwardly from the front wall at a first angle and the rear wall at a second angle that is different from the first angle with the first angle and the second angle substantially converging with each other to substantially form the apex.

18. The container of claim 15, wherein the rear wall includes a protrusion extending at an angle away from the base.

19. The container of claim 15, wherein the lid includes a first portion, a second portion extending at a first angle from the first portion and a third portion extending from the second portion at a second angle.

20. The container of claim 15, wherein the dividers include a first portion, a second portion extending at a first angle from the first portion and a third portion extending at a second angle from the second portion.
